(19) United States
(12) Patent Application Publication
(10) Pub. No.: US 2026/0278462 A1
(43) Pub. Date: Sep. 17, 2026

(54) DISTRIBUTED LEARNING BASED ON AUGMENTED INTELLIGENCE

(71) Applicant: Telefonaktiebolaget LM Ericsson (publ), Stockholm (SE)

(72) Inventors: Saravanan M, Chennai (IN); Perepu SATHEESH KUMAR, Chennai (IN)

(73) Assignee: Telefonaktiebolaget LM Ericsson, Stockholm (SE)

(21) Appl. No.: 19/469,096

(22) PCT Filed: Mar. 28, 2023
(86) PCT No.: PCT/IN2023/050292

§ 371 Date: Sep. 25, 2025

(51) Int. Cl. G06N 20/00

(52) U.S. Cl. CPC G06N 20/00

(57) ABSTRACT

A computer-implemented method for updating a global machine learning, ML, model using distributed learning is provided. The method comprises obtaining from a first group of one or more local computing devices weight values of a first group of one or more local ML models. The weight values of the first group of one or more local ML models are generated based on a first type of input data. The method further comprises obtaining from a second group of one or more local computing devices weight changing values. The weight changing values are generated based on a second type of input data. The method further comprises updating the global ML model based on the weight values of the first group of one or more local ML models and the weight changing values, thereby obtaining an updated global ML model. The method further comprises transmitting to the first group of one or more local computing devices the updated global ML model.

### TECHNICAL FIELD

This disclosure relates to distributed learning (DL) (e.g., federated learning) based on augmented intelligence.

### BACKGROUND

### Augmented Intelligence

Currently, various technical fields require artificial intelligence (AI) and its systems. Although many AI systems operate autonomously, augmented intelligence is important. Augmented intelligence is also known as intelligence amplification, cognitive augmentation, decision support, machine augmented intelligence, and enhanced intelligence.

It refers to using machines and devices to improve and enhance human tasks. More specifically, it uses machine learning and predictive analysis of datasets to improve human intelligence for better decisions. Therefore, augmented intelligence enables businesses to gain insights from various data without having to prepare, or process it. It also leverages machine learning, natural language processing (NLP), and automated insights to analyze data and provide rapid insights. It not only improves the decision-making process but also increases efficiency through actions taken.

### Federated Learning (FL)

FL is a framework for on-device collaborative training of machine learning (ML) models. FL may be useful in various scenarios. One exemplary scenario is as follows: An ML model is trained at a central computing device, and then distributed to clients. However, the performance of the distributed ML model is bad at some clients while it may be good at other clients e.g., due to inherent heterogeneity of local data distributions. For example, when the distributed ML model or a global ML model is run at client #1 using client data #1, the performance of the ML model may be good. On the other hand, when the distributed ML model is run at client #2 using client data #2, the performance of the ML model may be very bad because client data #2 is very different from client data #1 and/or the data used by the central computing device for training the ML model.

One way to solve the above problem is each of the clients sending to the central computing device the client data available at each of the clients such that the central computing device can train the ML model using the client data available at all clients. However, in some cases, the clients may not want to share such client data with the central computing device e.g., for privacy reason when the client data is confidential. FL solves this problem by a central computing device distributing a global ML model to clients, each client locally training the global ML model using local data, each client sending to the central computing device the locally trained ML model, and the central computing device combining the locally trained ML models, thereby generating an updated global ML model.

FL framework is designed to robustly deliver good predictive performance across individual clients with heterogeneous data. The approach disclosed in “Federated Learning with Heterogeneous Data: A Superquantile Optimization Approach,” 17 Dec. 2021, hinges upon a superquantile-based learning objective that captures the tail statistics of the error distribution over heterogeneous clients. Here, there is provided a stochastic training algorithm which interleaves differentially private client reweighting steps with federated averaging steps, and images and twitter data are used to experiment the concept and to show the heterogeneity in the process. In this article, it is assumed that similar data across all users is used for training an ML model.

While Federated Averaging (FedAvg) is the leading optimization method for training non-convex models, its behavior is not well understood in realistic federated settings when the devices/tasks are statistically heterogeneous, i.e., where each device collects data in a non-identical fashion. In “Federated Optimization for Heterogeneous Networks,” 2019, a framework called FedProx is introduced to tackle statistical heterogeneity. FedProx encompasses FedAvg as a special case. In this article, convergence guarantee for FedProx is provided through a device dissimilarity assumption. Also, in the article, a model is built based on Modified National Institute of Standards and Technology (MNIST) image data and the improved robustness and stability of FedProx for learning in heterogeneous networks are demonstrated. Like the article above in the preceding paragraph, in this article, it is assumed that similar data across all users is used for training an ML model.

In “Multimodal Federated Learning on IoT Data,” 2022, FL methods are applied to deal with multimodal data (e.g., text and images) where the FL workers do not have access to data of the same type. Unlike the two articles discussed in the two preceding paragraphs, in this article, different types of input data such as text and images are used for training an ML model.

### SUMMARY

Certain challenges presently exist. In FL, it is generally assumed that all clients deal with data of the same type and train ML models having the same architecture. However, there may be a scenario where the clients involved in FL run ML models having different architectures for e.g., different numbers of nodes in layers, different numbers of layers, different type of models etc. using different types of data e.g., numbers vs. text. For example, a central client may distribute two ML models having different architectures to two different users for local ML training, and combine the two different locally trained ML models to generate a global ML model. The existing FL framework is not optimized for handling such scenario. For example, the existing FL framework does not provide an optimal solution for combining the ML models that have different architectures and that are trained using data of different types.

In order to solve this problem, in some embodiments of this disclosure, augmented intelligence based FL is performed. In the augmented intelligence based FL, clients may be divided into a first group of clients for handling a first type of input data and a second group of clients for handling a second type of input data. The first group of clients may be used for building an ML model and a second group of clients may be used for enhancing the built ML model. By providing their intelligence to the ML model, the second group of users acts as augmented intelligence for improving the ML model. Therefore, some embodiments of this disclosure allow improving the global ML model via DL for e.g., FL that is based on different ML models which may have different architectures and which are trained using different types of training data.

More specifically, in one aspect of this disclosure, there is provided a computer-implemented method for updating a global machine learning, ML, model using distributed learning. The method comprises obtaining from a first group of one or more local computing devices weight values of a first group of one or more local ML models, wherein the weight values of the first group of one or more local ML models are generated based on a first type of input data. The method further comprises obtaining from a second group of one or more local computing devices weight changing values, wherein the weight changing values are generated based on a second type of input data, and further wherein the first type of input data and the second type of input data are different. The method further comprises updating the global ML model based on the weight values of the first group of one or more local ML models and the weight changing values, thereby obtaining an updated global ML model. The method further comprises transmitting to the first group of one or more local computing devices the updated global ML model.

In another aspect, there is provided a computer-implemented method for updating a global machine learning, ML, model using distributed learning. The method comprises obtaining from a global computing device a global ML model, updating the global ML model using first local data, thereby generating a first local ML model, and updating the global ML model using second local data, thereby generating a second local ML model. The method further comprises generating weight changing values using the first local ML model and the second local ML model; and transmitting to the global computing device the weight changing values for updating the global ML model at the global computing device.

In another aspect, there is provided a computer program comprising instructions which when executed by processing circuitry cause the processing circuitry to perform the method of at least one of the embodiments described above.

In another aspect, there is provided a carrier containing the computer program of the embodiments described above, wherein the carrier is one of an electronic signal, an optical signal, a radio signal, and a computer readable storage medium.

In another aspect, there is provided an apparatus for updating a global machine learning, ML, model using distributed learning. The apparatus is configured to obtain from a first group of one or more local computing devices weight values of a first group of one or more local ML models, wherein the weight values of the first group of one or more local ML models are generated based on a first type of input data. The apparatus is further configured to obtain from a second group of one or more local computing devices weight changing values, wherein the weight changing values are generated based on a second type of input data, and further wherein the first type of input data and the second type of input data are different. The apparatus is further configured to update the global ML model based on the weight values of the first group of one or more local ML models and the weight changing values, thereby obtaining an updated global ML model. The apparatus is further configured to transmit to the first group of one or more local computing devices the updated global ML model.

In another aspect, there is provided an apparatus for updating a global machine learning, ML, model using distributed learning. The apparatus is configured to obtain from a global computing device a global ML model, update the global ML model using first local data, thereby generating a first local ML model, and update the global ML model using second local data, thereby generating a second local ML model. The apparatus is further configured to generate weight changing values using the first local ML model and the second local ML model, and transmit (s610) to the global computing device the weight changing values for updating the global ML model at the global computing device.

In another aspect, there is provided an apparatus comprising a memory; and processing circuitry coupled to the memory, wherein the apparatus is configured to perform the method of any one of the embodiments described above.

As discussed above, some embodiments of this disclosure enable augmented intelligence, e.g., building a global ML model by combining ML models that were trained locally using different types of local input data and that may have different architectures, thereby increasing the performance of the ML model. By enabling to build a global ML model using different types of input data, embodiments of this disclosure can be implemented in many real-life scenarios. Also because the global ML model can be built based on various types of input data, the accuracy of the global ML model can be improved, which may lead to cost reduction) For example, in case the global ML model is used for detecting a fault in an industry such as in a manufacturing factory or a network, the accuracy of the global ML model in detecting a fault can be improved.

### BRIEF DESCRIPTION OF THE DRAWINGS

The accompanying drawings, which are incorporated herein and form part of the specification, illustrate various embodiments.

FIG. 1 shows a system according to some embodiments.

FIG. 2 shows a process according to some embodiments.

FIG. 3 illustrates a method of combining ML models having different architectures.

FIG. 4 shows a comparison between performance of a conventional FL and performance of an ML learning according to some embodiments.

FIG. 5 shows a process according to some embodiments.

FIG. 6 shows a process according to some embodiments.

FIG. 7 shows an apparatus according to some embodiments.

### DETAILED DESCRIPTION

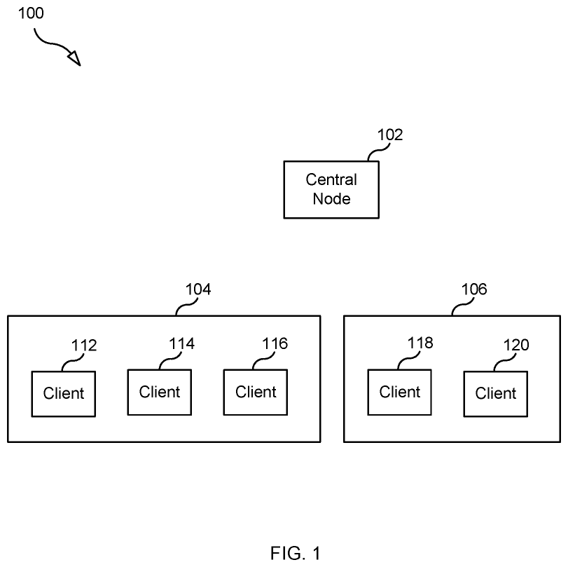

FIG. 1 shows a system 100 according to some embodiments. System 100 may comprise a global node 102, a first group 104 of local computing devices, hereinafter referred as clients and a second group 106 of clients. First group 104 of clients includes a first client 112, a second client 114, and a third client 116, and second group 106 of clients includes a fourth client 118 and a fifth client 120. Note that the number of client groups and/or the number of clients included in each client group shown in FIG. 1 are provided for simple explanation purpose only, and they do not limit the embodiments of this disclosure in any way.

In one example, each of clients 112-120 corresponds to a base station (e.g., gNB), and central node or global computing device 102 corresponds to a network node controlling clients 112-120. In this example, each of the base stations 112-120 may be configured to run an ML model for adjusting configuration(s) of a wireless network provided by the base stations 112-120. In another example, each of clients 112-120 corresponds to a manufacturing robot in a factory, and central node 102 corresponds to a controlling entity that controls the manufacturing robots. In this example, each of the robots may be configured to run an ML model for detecting a fault in its operation.

In this disclosure, a client or a local computing device 104, 106 is any computing device of capable of obtaining input data, training an ML model using the input data, and transmitting model data e.g., weight values of an ML model indicating the trained ML model to another computing device e.g., global node 102. Each client may obtain the input data by i) performing some kinds of measurement(s) from which input data is generated, ii) storing in and retrieving from a memory input data, and/or iii) receiving input data from a different entity for e.g., a different client or a human. Examples of the client are a mobile phone, a tablet, a laptop, a vehicle, an airplane, a robot, an Internet of Things (IoT) device, etc.

In this disclosure, a global node or a global computing device 102 is any computing device capable of obtaining model data for e.g., weight values of ML model(s) indicating ML models, generating an updated ML model based on the obtained ML models, and transmitting the updated ML model to different entities e.g., the clients. The global node may obtain the ML models by receiving from each of one or more clients model data for e.g., weight values of an ML model indicating an ML model. Examples of the global computing device are a server, a network node, a gateway, a router, etc.

As shown in FIG. 1, clients 112-116 belong to the same client group 104. Thus, according to some embodiments, the type of input data available at clients 112-116 is the same. Similarly, since clients 118 and 120 belong to the same client group 106, the type of input data available at clients 118 and 120 may be the same. On the contrary, since clients 112-116, and clients 118 and 120 belong to different client groups 104 and 106 respectively, the type of input data available at clients 112-116 and the type of input data available at clients 118 and 120 may be different. For example, the type of input data available at clients 112-116 may be numerical values such as, values of measurements performed by sensor(s); while the type of input data available at clients 118 and 120 may be text data such as, text input entered by a human user.

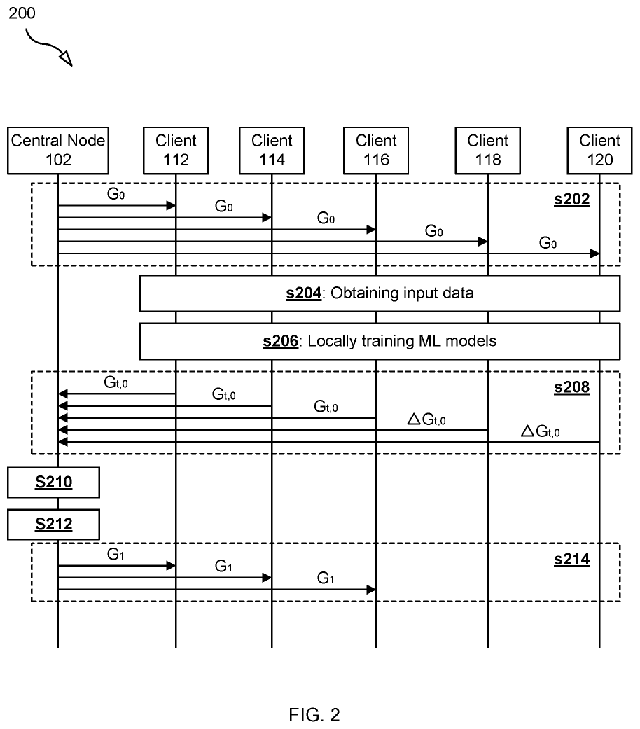

FIG. 2 shows a process 200 performed by system 100 according to some embodiments. Via process 200 shown in FIG. 2, augmented intelligence-based FL can be performed based on heterogeneous data i.e., different types of data.

Process 200 may begin with step s202. Step s202 comprises global node 102 distributing an initial global ML model a.k.a., an initial common ML model to clients 112-120. As a result of performing step s202, at this stage, all clients 112-120 have the ML models having the same architecture—i.e., the initial global ML model. The global ML model may be expressed as Gᵢ where i indicates a current iteration. Here, since this is the first iteration, i for the initial global ML model may be equal to 0.

After performing step s202, process 200 may proceed to step s204. Step s204 comprises each of clients 112-120 obtaining input data needed for training the ML model obtained in step s202. As discussed above, each client may obtain the input data by i) performing some kinds of measurement(s), ii) storing in and retrieving from a memory input data, or iii) receiving input data from a different entity for e.g., a different client or a human.

The types of input data that clients 112-120 obtain in step s204 may be different among the clients. More specifically, the type of input data that clients 112, 114, and 116 obtain in step s204 may be first type of input data while the type of input data that clients 118 and 120 obtain in step s204 may be second type of input data. One example of the first type of input data is numeric data and one example of the second type of input data is text data.

The type of input data each client obtains in step s204 may be associated with a classification of the client. For example, a client that is configured to obtain the first type of input data may be classified as a first user group while a client that is configured to obtain the second type of input data may be classified as a second user group. As explained below, this classification of a UE may determine the type of data that each client would report to central node 102 in step s208.

Note that even though FIG. 2 shows that step s204 is performed after step s202, in some embodiments, step s204 may be performed before step s202. Also, in other embodiments, step s204 may be performed before and after step s202—meaning that the input data for training the ML models may be obtained before and after step s202. Here, the input data is only available locally—meaning that the input data available at each of clients 112-120 is not available at global node 102, which means that training of the ML models using the input data is performed at the clients.

In some embodiments, the frequency of obtaining the input data may be different among the clients. In one example, the frequency of each of clients 112, 114, and 116 obtaining the first type of input data may be twice of the frequency of each of clients 118 and 120 obtaining the second type of input data. Table 1 provided below illustrates this example.

TABLE 1

| | Client 112 | Client 114 | Client 116 | Client 118 | Client 120 |
|---|---|---|---|---|---|
| t₀ | Input data #1₁₁₂ | Input data #1₁₁₄ | Input data #1₁₁₆ | Input data #1₁₁₈ | Input data #1₁₂₀ |
| t₁ | Input data #2₁₁₂ | Input data #2₁₁₄ | Input data #2₁₁₆ | | |
| t₂ | Input data #3₁₁₂ | Input data #3₁₁₄ | Input data #3₁₁₆ | Input data #2₁₁₈ | Input data #2₁₂₀ |
| t₃ | Input data #4₁₁₂ | Input data #4₁₁₄ | Input data #4₁₁₆ | | |

In another example, the frequency of each of clients 118 and 120 obtaining the second type of input data may be twice of the frequency of each of clients 112, 114, and 116 obtaining the first type of input data. Table 2 provided below illustrates this example.

TABLE 2

| | Client 112 | Client 114 | Client 116 | Client 118 | Client 120 |
|---|---|---|---|---|---|
| t₀ | Input data #1₁₁₂ | Input data #1₁₁₄ | Input data #1₁₁₆ | Input data #1₁₁₈ | Input data #1₁₂₀ |
| t₁ | | | | Input data #2₁₁₈ | Input data #2₁₂₀ |
| t₂ | Input data #2₁₁₂ | Input data #2₁₁₄ | Input data #2₁₁₆ | Input data #3₁₁₈ | Input data #3₁₂₀ |
| t₃ | | | | Input data #4₁₁₈ | Input data #4₁₂₀ |

After performing step s204, process 200 may proceed to step s206. Step s206 comprises each of clients 112-120 locally training its ML model (i.e., the ML model obtained at step s202) using the input data obtained in step s204, thereby updating the ML model. The ML model updated at each of the clients in step s206 may be expressed as G_{t,i} where t indicates that this ML model is a temporary ML model, and i indicates a current iteration of learning. Here, since this is the first iteration, i may be equal to 0.

Table 3 below shows an example of the updated ML models at the clients using the input data shown in Table 1 above.

TABLE 3

| | Client 112 | Client 114 | Client 116 | Client 118 | Client 120 |
|---|---|---|---|---|---|
| t₀′ | $G {1}_{t , 0}^{112}$ | $G {1}_{t , 0}^{114}$ | $G {1}_{t , 0}^{116}$ | $G {1}_{t , 0}^{118}$ | $G {1}_{t , 0}^{120}$ |
| t₁′ | $G {2}_{t , 0}^{112}$ | $G {2}_{t , 0}^{114}$ | $G {2}_{t , 0}^{116}$ | | |
| t₂′ | $G {3}_{t , 0}^{112}$ | $G {3}_{t , 0}^{114}$ | $G {3}_{t , 0}^{116}$ | $G {2}_{t , 0}^{118}$ | $G {2}_{t , 0}^{120}$ |
| t₃′ | $G {4}_{t , 0}^{112}$ | $G {4}_{t , 0}^{114}$ | $G {4}_{t , 0}^{116}$ | | |

Here,

$$G {1}_{t , 0}^{112}$$

is obtained by updating the initial global ML model obtained in step s202 using Input data #1₁₁₂.

$$G {2}_{t , 0}^{112}$$

is obtained by updating

$$G {1}_{t , 0}^{112}$$

using Input data #2₁₁₂.

$$G {3}_{t , 0}^{112}$$

is obtained by updating

$$G {2}_{t , 0}^{112}$$

using Input data #3₁₁₂.

$$G {4}_{t , 0}^{112}$$

is obtained by updating

$$G {3}_{t , 0}^{112}$$

using Input data #4₁₁₂.

$$G {1}_{t , 0}^{118}$$

is obtained by updating the initial global ML model obtained in step s202 using Input data #1₁₁₈.

$$G {2}_{t , 0}^{118}$$

is obtained by updating the initial global ML model obtained in step s202 using Input data #2₁₁₈. Other ML models shown in Table 3 are updated in the similar manner, and thus explanation as to how the other ML models are updated is omitted.

Table 4 below shows an example of the updated ML models at the clients using the input data shown in Table 2 above.

TABLE 4

| | Client 112 | Client 114 | Client 116 | Client 118 | Client 120 |
|---|---|---|---|---|---|
| t₀′ | $G {1}_{t , 0}^{112}$ | $G {1}_{t , 0}^{114}$ | $G {1}_{t , 0}^{116}$ | $G {1}_{t , 0}^{118}$ | $G {1}_{t , 0}^{120}$ |
| t₁′ | | | | $G {2}_{t , 0}^{118}$ | $G {2}_{t , 0}^{120}$ |
| t₂′ | $G {2}_{t , 0}^{112}$ | $G {3}_{t , 0}^{114}$ | $G {3}_{t , 0}^{116}$ | $G {3}_{t , 0}^{118}$ | $G {3}_{t , 0}^{120}$ |
| t₃′ | | | | $G {4}_{t , 0}^{118}$ | $G {4}_{t , 0}^{120}$ |

After performing step s206, process 200 may proceed to step s208. Step s208 comprises each of clients 112-116 sending to the central node 102 the output of updating its ML models, i.e., the output of step s204. The type of the output each client reports to the central node 102 may depend on the classification of the client. More specifically, in some embodiments, the clients belonging to the first user group, i.e., clients 112, 114, and 116 may report to the central node 102 the updated ML models while the clients belonging to the second user group, i.e., clients 118 and 120 may report to the central node 102 how much the ML models are updated.

For instance, in the example provided in Table 3 above, at t₂′, the clients belonging to the first user group, i.e., clients 112, 114, and 116, may report to the central node 102 the weight values of the updated ML models

$$G {3}_{t , 0}^{112} , G {3}_{t , 0}^{114} , and G {3}_{t , 0}^{116} .$$

On the other hand, the clients belonging to the second user group, clients 118 and 120, may report to the central node 102 the gradients of the updated ML models, i.e., the weight values of

$$( G {2}_{t , 0}^{118} - G {1}_{t , 0}^{118} )$$

and the weight values of

$$( G {2}_{t , 0}^{120} - G {1}_{t , 0}^{120} ) .$$

This may be related to various factors related to the first type of input data and the second type of input data. For example, in case the first type of input data is more accurate than the second type of input data, more weight should be given to the first type of input data when updating the initial global ML model. In such case, it can be configured such that the weight values of the ML models that were trained based on the first type of input data contribute more to updating the initial global ML model as compared to the weight values of the ML models that were trained based on the second type of input data.

More specifically, in one example, more weights can be given to the ML models that were trained based on the first type of input data by updating the initial global ML model using (1) the weight values of the ML models trained based on the first type of input data and (2) the gradients of the ML models trained based on the second type of input data. Here, because the first input data is given more weight, the first user group is also called as a main user group or a main user while the second user group is called a sub-user group or a sub-user. Thus, in FIG. 1, the group 104 corresponds to a main user group and the group 106 corresponds to a sub-user group.

In some embodiments, when distributing the initial global ML model, central node 102 may indicate to each of clients 112-120 whether the client corresponds to a main user or a sub user.

The gradient of an ML model may be calculated as follows: First, the ML model obtained in step s202 is trained by client 118 or 120 using input data #1 that becomes available at t=t0. Then, the trained ML model is trained again by client 118 or 120 using input data #2 that becomes available at t=t1. The differences between the weight values of the ML model that was trained using input data #1 and the weight values of the ML model that was trained using input data #2 correspond to the gradients—the weight changing values. In a summary, the weight changing values indicate weight updates calculated at the end of epochs when the ML model is converged. Here, the weight changing values may be expressed as ΔG_{t,i} where t indicates that the involved ML model is a temporary ML model, and i indicates a current iteration of learning. Here, since this is the first iteration, i may be equal to 0.

After performing step s206, process 200 may proceed to step s208. Step s208 comprises each of clients 112-116 transmitting to global node 102 model data e.g., weight values of the updated ML models indicating the ML models trained at clients 112-116 and each of clients 118 and 120 transmitting to global node 102 weight changing values indicating how much the ML models at clients 118 and 120 are changed by the training.

After performing step s208, process 200 may proceed to step s210. Step s210 comprises combining e.g., averaging, weight values of the ML models, thereby calculating combined e.g., averaged weight values, and combining e.g., averaging weight changing values of the ML models, thereby calculating combined e.g., averaged weight changing values.

More specifically, in some embodiments, a temporal global ML model corresponding to the averaged weight values may be calculated as follows:

$${G}_{temp} = \frac{{\sum }_{j = 1}^{M} {G}_{{j}_{t , i}}}{M}$$

where M is the number of clients included in first group 104, and i indicates a current iteration of learning. Here, since this is the first iteration, i may be equal to 0.

In one specific example, in case the ML model trained at client 112 has two weight values W1₁₁₂ and W2₁₁₂, the ML model trained at client 114 has two weight values W1₁₁₄ and W2₁₁₄, and the ML model trained at client 116 has two weight values W1₁₁₆ and W2₁₁₆, the temporary global ML model may have two weight values W1ₜ and W2ₜ, where

$$W {1}_{t} = \frac{W {1}_{112} + W {1}_{114} + W {1}_{116}}{3} and W {2}_{t} = \frac{W {2}_{112} + W {2}_{114} + W {2}_{116}}{3} .$$

Note that the number weight values associated with each client can be any number.

Similarly, in some embodiments, a temporary gradient global ML model corresponding to the averaged weight changing values may be calculated as follows:

$$Δ {G}_{temp} = \frac{{\sum }_{j = 1}^{N} Δ {G}_{{j}_{t , i}}}{N}$$

where N is the number of clients included in second group 106, i indicates a current iteration of learning. Here, since this is the first iteration, i may be equal to 0.

In one specific example, in case the ML model trained at client 118 has two weight values W1_{118 at t=t0} and W2_{118 at t=t0} at t=t0, the ML model trained at client 118 has two weight values W1_{118 at t=t1} and W2_{118 at t=t1} at t=t1, the ML model trained at client 120 has two weight values W1_{120 at t=t0} and W2_{120 at t=t0} at t=t0, and the ML model trained at client 120 has two weight values W1_{120 at t=t1} and W2_{120 at t=t1} at t=t1, the temporary gradient global ML model may have two averaged weight changing values ΔW1t and ΔW2t, where.

$$Δ W {1}_{t} = \frac{( W {1}_{118 at t = t 1} - W {1}_{118 at t = t 0} ) + ( W {1}_{120 at t = t 1} - W {1}_{120 at t = t 0} )}{2} and Δ W {2}_{t} = \frac{( W {2}_{118 at t = t 1} - W {2}_{118 at t = t 0} ) + ( W {2}_{120 at t = t 1} - W {2}_{120 at t = t 0} )}{2} .$$

Note that the number weight changing values associated with each client can be any number.

After performing step s210, process 200 may proceed to step s212. Step s212 comprises obtaining an updated global ML model—by calculating weight values of the updated global ML model based on the temporary global ML model and the temporary gradient global ML model. In some embodiments, the weight values of the updated global ML model may be calculated as follows:

$${G}_{i} = {G}_{temp} + αΔ {G}_{temp}$$

Here α may be less than 1 because the gradients are mainly used for improving the global ML model, and thus less weight should be given to it.

Referring back to the specific examples provided above, the weight values of the updated global ML model W1 and W2 can be calculated as follows: W1=W1ₜ+αΔW1ₜ and W2=W2ₜ+αΔW2ₜ.

There may be a scenario where either Gₜₑₘₚ or ΔGₜₑₘₚ is not available. For instance, in the example provided in Table 3 above, at t0′, Gₜₑₘₚ from each of clients 112-116 (i.e.,

$$G {1}_{t , 0}^{112}$$

from client 112,

$$G {1}_{t , 0}^{114}$$

from client 114, and

$$G {1}_{t , 0}^{116}$$

from client 116) is available while ΔGₜₑₘₚ from each of clients 118 and 120 is not available because each of the clients 118 and 120 did not have enough input data to update its ML model

$$\begin{matrix}( i . e . , G {2}_{t , 0}^{112} \\ and G {2}_{t , 0}^{120}\end{matrix}$$

needed for calculating

$$Δ {G}_{118} = G {2}_{t , 0}^{118} - G {1}_{t , 0}^{118} and Δ {G}_{120} = G {2}_{t , 0}^{120} - G {1}_{t , 0}^{120}$$

are not available at t₀′). In such scenario, Gᵢ=Gₜₑₘₚ (i.e., the global ML model is updated solely based on the updated ML models received from the first group of clients).

On the other hand, in the example provided in Table 4 above, at t₁′, ΔGₜₑₘₚ from each of the clients 118 and 120

$$( i . e . Δ {G}_{118} = ( G {2}_{t , 0}^{118} - G {1}_{t , 0}^{118} )$$

from client 118 and

$$Δ {G}_{120} = ( G {2}_{t , 0}^{120} - G {1}_{t , 0}^{120} )$$

from client 120) is available while Gₜₑₘₚ from each of the clients 112-116 is not available (note that

$$G {2}_{t , 0}^{112} , G {2}_{t , 0}^{114} , G {2}_{t , 0}^{116}$$

is not available until t₂′). In such scenario, Gᵢ=Gᵢ₋₁+αΔGₜₑₘₚ (i.e., the global ML model is updated based on the previously updated global ML model and the gradients of the locally updated ML models).

After obtaining the global ML model, step s214 may be performed. Step s214 comprises transmitting model data for e.g., weight values of the updated global ML model, indicating the updated global ML model to first group 104, a.k.a., the main user group. Note that, in step s214, the updated global model is not transmitted to second group 106, a.k.a., the sub-user group. After performing steps 214, steps 204-214 may be repeatedly performed.

In repeatedly performing steps s206, first group 104 of clients and second group 106 of clients may perform differently. More specifically, first group 104 of clients may perform step s206 using the updated global ML model (e.g., G₁) obtained from step s214 in the previous iteration. On the other hand, second group 106 of clients may perform s206 using the initial global ML model (e.g., G₀) obtained from step s202 in the first iteration. The rationale is as follows: here, second group 106 of clients 118 and 120 is acting as passing augmented knowledge to the existing global model. Hence, obtaining the global ML model every time or epoch is not required for these clients. Instead, second group 106 of clients may use a global model obtained at a specific iteration for performing the local ML model training. In one example, second group 106 of clients may use the initial global model (i.e., the global model at zeroth iteration) for performing the local ML model training. Note that the global model that second group 106 of clients may use for performing the local ML training is not limited to the initial global model but can be any global model that second group 106 of clients can obtain.

Thus, during the second iteration, the output of step s206 for first group 104 of clients may be weight values of the newly obtained global ML models G₁ that were trained using different input data while the output of step s206 for second group 106 of clients may be weight changing values of the initial global ML model G₀ that were trained using different input data.

In the above examples, the temporary global ML model Gₜₑₘₚ\ and the temporary gradient global ML model ΔGₜₑₘₚ are assumed to have the same model architectures for e.g., same numbers of nodes in layers, same numbers of layers, etc. In some scenarios, however, the temporary global ML model Gₜₑₘₚ and the temporary gradient global model ΔGₜₑₘₚ may have different model architectures. In such scenarios, combining the two models having different model architectures is not as straightforward as combining the two models when they have the same model architecture. Sample illustrations for combining models having the same model architecture and those having the different model architecture are explained below.

### Combining ML Models Having the Same Model Architecture

Combining ML models having the same model architecture is straightforward as it can be done by simply averaging weight values of the ML models. But, in case of combining multiple recurrent neural network (RNN) models, there is a slight change. Generally, RNN models contain embedding layer(s) followed by fully connected layer(s). Thus, in case of combining RNN models, only weight values corresponding to fully connected layers are combined i.e., without combining weight values embedding layers.

Combining ML models having different model architectures

Any neural network (NN) models contains two aspects—(i) one aspect that is specific to the model architecture and (ii) another aspect that is specific to fully connected layers. For example, a convolution neural network (CNN) model contains convolutional layer(s) which is specific to CNN model architecture that is followed by fully connected layer(s) at the end. On the contrary, an RNN model contains embedding layer(s) followed by fully connected layer(s).

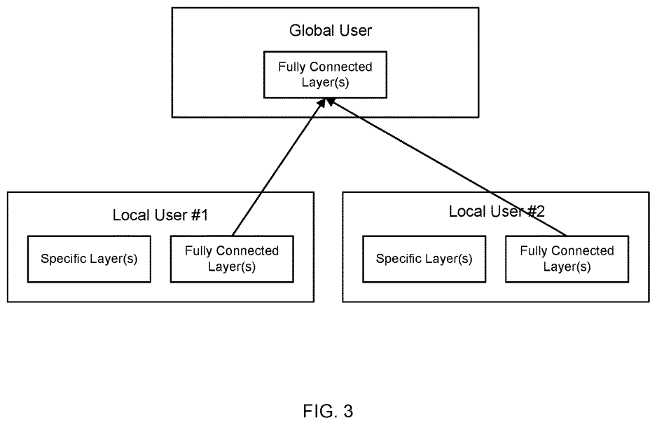

There are various ways of combining ML models having different model architectures. For example, as explained in WO 2021/064737 (the disclosure of which is incorporated by reference) one way of combining ML models having different model architectures is combining weight values of only fully connected layers in the ML models, thereby generating common fully connected layer(s) in the global ML model, as illustrated in FIG. 3. The rationale is that since fully connected layers contain more information on the classification accuracy, only these layers need to be combined in order to improve the overall accuracy. As well known in the art, two fully connected layers means that each of every neurons (nodes) in one layer is connected to every neurons in the subsequent layer.

Another way of combining ML models having different model architectures is using knowledge distillation. In this way, via knowledge distillation, ML models having different model architectures are converted into ML models having the same architecture. The process of performing the knowledge distillation is as follows:
1. Initialize the global architecture of an ML model to be used.
2. Train a local ML model of any architecture with local private training data.
3. Convert the trained local ML model to an ML model having the initialized global architecture using the process of knowledge distillation.
4. Transmit the distilled ML model to the global user and perform general federated learning, thereby generating an updated global ML model.
5. Distributing the updated global ML models to local users.

For every FL iteration, steps 2-5 described above may be repeatedly performed.

### Exemplary Use Case Scenario #1

Assume that there is a need to configure each of base stations (gNBs) in a communication network to perform fault detection by predicting a fault status with respect to its own operation. The prediction may be based on measure data such as sensor data it collects for e.g., a numeric value corresponding to a value of Reference Signal Received Power (RSRP). For performing the fault detection, an ML model may be used. Further assume that there are engineers checking the status of the wireless networks of the gNBs and the engineers providing feedback, for example, text input of ‘the gNB may fail if the RSRP will increase more than −90 dBm’, directed to the networks of the gNBs is available at a group of network nodes.

In the above scenario, it is desirable to train the ML model based not only on the measurement data but also on the feedback provided by engineers. However, there are two potential problems: (1) the types of the input data i.e. the measurement data and feedback data which is available for training the ML model are different; and (2) due to the risk of potential hacking or other privacy concerns, it may be desirable not to transfer the collected measurement data and the collected feedback from one computing device to another computing device. Note that, in order to train the ML model using the collected measurement data and the collected feedback, generally, the data need to be transferred from the collecting computing devices to the computing device that performs the ML training.

Using the embodiments described above, an ML model associated with each gNB may be trained using the collected measurement data and an ML model associated with each engineer or each group of opinions from engineer(s) may be trained using the collected feedback, and the trained ML models associated with the gNBs and the engineers/groups of opinions may be combined using the above explained augmented intelligence based FL. By removing the need of transmitting the collected measurement data and the collected engineers' opinions, the issue that may arise from potential hacking or other privacy concerns may be avoided. Thus, by using the augmented intelligence based FL, ML models that have different architectures and that are trained using different types of input data may be used for training the global or common ML model.

Let's assume that an ML model associated with each gNB (i.e., a main user) comprises a 2-layer long short-term memory (LSTM) followed by two fully connected layers—a first layer of 4 nodes and a second layer of 2 nodes—, an ML model associated with each engineer or each group of engineer (i.e., a sub user) opinions comprises a 3-layer LSTM followed by two fully connected layers-a first layer of 4 nodes and a second layer of 2 nodes—, and a global ML model comprises a two fully connected layers—a first layer of 4 nodes and a second layer of 2 nodes.

As explained above, one way of combining the ML models associated with the main users and gradients of the ML models associated with the sub-users is combining only the information directed to fully connected layers.

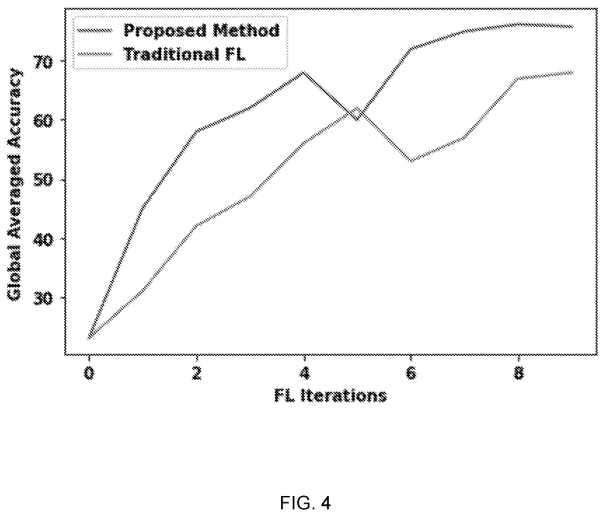

As shown in FIG. 4, as compared to applying general FL without using data from sub-users (e.g., the textual data from the engineers), augmented intelligence based FL according to some embodiments achieves an 8% increase in accuracy. Here the architecture of the main user is a 2-layer LSTM with 8 input nodes followed by fully connected layers of 4 and 2 nodes, and the architecture of the sub-user is a 3-layer LSTM with 8 input nodes followed by fully connected layers of 4 and 2 nodes.

### Exemplary Use Case Scenario #2

Nowadays, manufacturing industries are becoming autonomous with a minimal human intervention. However, detecting faults in manufacturing operations based solely on sensor data may not be accurate. In such scenario, additionally relying on expert(s)' opinions regarding the manufacturing operations is helpful in detecting faults.

However, there are two potential problems: (1) the types of the input data i.e., the sensor data and expert opinion data which is available for training the ML model are different; and (2) due to the risk of potential hacking or other privacy concerns, it may be desirable not to transfer the collected images and the coordinate data from one computing device to another computing device. Note that, in order to train the ML model using the collected images and the collected coordinate data, generally, the collected images and the collected coordinate data need to be transferred from the collecting computing devices to the computing device that performs the ML training.

Using the embodiments described above, an ML model associated with each sensor may be trained using the collected sensor data and an ML model associated with each expert or each group of expert opinions may be trained using the collected expert opinions, and the trained ML models associated with the sensors and the experts/experts opinions may be combined using the above explained augmented intelligence based FL. By removing the need of transmitting the collected sensor data and the collected experts' opinions, the issue that may arise from potential hacking or other privacy concerns may be avoided. Thus, by using the augmented intelligence-based FL, ML models that have different architectures and that are trained using different types of input data may be used for training the global or common ML model.

### Exemplary Use Case Scenario #3

Different categories of unmanned aerial vehicles (UAVs) are involved in city planning. For example, a first category of UA Vs may collect images while a second category of UAVs may collect coordinate data, and the collected images and the collected coordinate data may be used for city planning. In performing the city planning, an ML model may be used.

However, there are two potential problems: (1) the types of the input data i.e. the coordinate data and image data which is available for training the ML model are different; and (2) due to the risk of potential hacking or other privacy concerns, it may be desirable not to transfer the collected images and the coordinate data from one computing device to another computing device (Note that, in order to train the ML model using the collected images and the collected coordinate data, generally, the collected images and the collected coordinate data need to be transferred from the collecting computing devices to the computing device that performs the ML training).

Using the embodiments described above, an ML model may be provided for each UAV, and each of the ML models may be trained using the collected images or the collected coordinate data (i.e., the data that is available at each UAV). The trained ML models of the UAVs may be combined using the above explained augmented intelligence-based FL. By removing the need of transmitting the collected images and the collected coordinate data from one computing device to another computing device, the risk of potential hacking or other privacy concerns can be prevented. Thus, by using the augmented intelligence-based FL, ML models that have different architectures and that are trained using different types of input data may be used for training the global or common ML model.

### Exemplary Use Case Scenario #4

In network slicing, network slices of different requirements may be created. Because these network slices might belong to different companies, sharing data of these different network slices may lead to privacy issues. Using FL may be helpful in resolving the privacy issues. But, depending on the application, for example, conversational video, mobile Internet of Things (mIoT), etc. for which network slices are created, these network slices can carry different types of data (e.g., a video, text, etc.). Some embodiments of this disclosure can be used to build a global ML model for these network slices by combining these different types of data, thereby controlling respective KPI of each of the network slices.

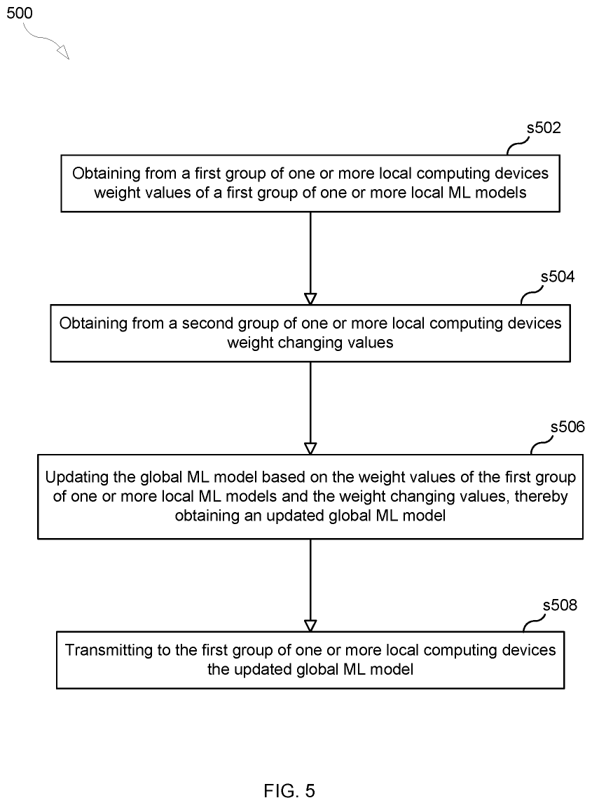

FIG. 5 shows a process 500 for updating a global ML model using distributed learning, according to some embodiments. Process 500 may begin with step s502. Step s502 comprises obtaining from a first group of one or more local computing devices weight values of a first group of one or more local ML models, wherein the weight values of the first group of one or more local ML models are generated based on a first type of input data. Step s504 comprises obtaining from a second group of one or more local computing devices weight changing values, wherein the weight changing values are generated based on a second type of input data, and further wherein the first type of input data and the second type of input data are different. Step s506 comprises updating the global ML model based on the weight values of the first group of one or more local ML models and the weight changing values, thereby obtaining an updated global ML model. Step s508 comprises transmitting to the first group of one or more local computing devices the updated global ML model.

In some embodiments, the updated global ML model are not transmitted to the second group of one or more local computing devices.

In some embodiments, a weight changing value included in the weight changing values corresponds to a difference between a weight value of a first local ML model and a weight value of a second local ML model.

In some embodiments, the process 500 comprises, before obtaining the weight values of the first group of one or more local ML models and the weight changing values, transmitting weight values of the global ML model to the first group of one or more local computing devices and the second group of one or more local computing devices.

In some embodiments, the second group of one or more local computing devices includes a first local computing device, the first local ML model is obtained by updating the global ML model at the first local computing device using first local data which is of the second type, and the second local ML model is obtained by updating the global ML model at the first local computing device using second local data which is of the second type.

In some embodiments, obtaining the weight changing values comprises receiving from the first local computing device the weight changing value, and the first local computing device transmitted the weight changing value when one or more preconditions are satisfied.

In some embodiments, said one or more preconditions include one or more of: availability of the first local data, availability of the second local data, or elapse of a predefined time interval.

In some embodiments, the process 500 comprises combining the weight values of the first group of one or more local computing devices, thereby generating combined weight values, wherein the global ML model is updated based on the combined weight values.

In some embodiments,

$${G}_{m} = {\sum }_{j = 1}^{N} {l}_{m , j} ,$$

where Gₘ is m-th combined weight value included in the combined weight values, 1≤m≤M, M is a total number of the combined weight values, l_{m,j} is m-th weight value of an j-th local ML model included in the first group of one or more local ML models, and N is a total number of ML models included in the first group of one or more local ML models.

In some embodiments, the process 500 comprises combining the weight changing values, thereby generating combined weight changing values, wherein the global ML model is updated based on the combined weight changing values.

In some embodiments,

$$Δ {G}_{n} = {\sum }_{j = 1}^{N} Δ {G}_{n , j} ,$$

where ΔGₙ is n-th combined weight changing value included in the combined weight changing values, 1≤n≤M′, M′ is a total number of the combined weight changing values, ΔG_{n,j} is n-th weight changing value associated with j-th local computing device included in the second group of one or more local computing devices, and Nis a total number of local computing devices included in the second group of one or more local computing devices.

In some embodiments, the process 500 comprises applying an adjusting value to the combined weight changing values; and combining the combined weight values and the adjusted-combined weight changing values, wherein the global ML model is updated based on the combination.

In some embodiments, the combined weight values and the adjusted-combined weight changing values are combined using knowledge distillation.

In some embodiments, Gₘ=G_{m-th combined weight value}+αG_{m-th combined weight changing value} where Gₘ is an m-th weight value of the updated global ML model, G_{m-th combined weight value} is an m-th combined weight value in the combined weight values, G_{m-th combined weight changing value} is an m-th combined weight changing value in the combined weight changing values, and α is the adjusting value.

In some embodiments, a local computing device included in the first group of one or more local computing devices is a first base station in a communication network, a local computing device included in the second group of one or more local computing devices is a second base station in the communication network, the updated global ML model is configured to generate an output value indicating a faulty operation of the first base station based on the first type of input data; and each of the second local ML model and the third local ML model is configured to generate an output value indicating a faulty operation of the second base station based on the second type of input data.

In some embodiments, a local computing device included in the first group of one or more local computing devices is a first manufacturing device, a local computing device included in the second group of one or more local computing devices is a second manufacturing device, the updated global ML model is configured to generate an output value indicating a faulty manufacturing operation of the first manufacturing device based on the first type of input data; and each of the second local ML model and the third local ML model is configured to generate an output value indicating a faulty manufacturing operation of the second manufacturing device based on the second type of input data.

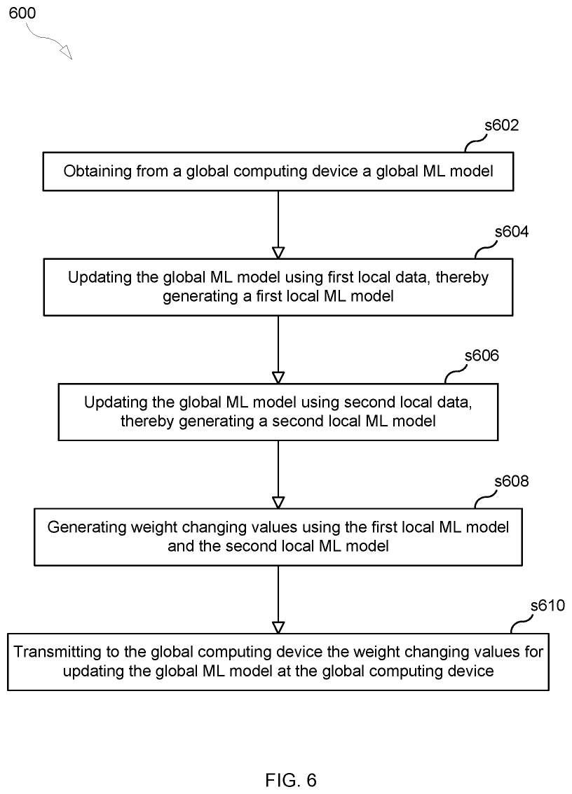

FIG. 6 shows a process 600 for updating a global ML model using distributed learning, according to some embodiments. Process 600 may begin with step s602. Step s602 comprises obtaining from a global computing device a global ML model. Step s604 comprises updating the global ML model using first local data, thereby generating a first local ML model. Step s606 comprises updating the global ML model using second local data, thereby generating a second local ML model. Step s608 comprises generating weight changing values using the first local ML model and the second local ML model. Step s610 comprises transmitting to the global computing device the weight changing values for updating the global ML model at the global computing device.

In some embodiments, a weight changing value included in the weight changing values corresponds to a difference between a weight value of the first local ML model and a weight value of the second local ML model.

In some embodiments, the weight changing values are transmitted to the global computing device when one or more preconditions are satisfied.

In some embodiments, said one or more preconditions include one or more of: availability of the first local data, availability of the second local data, or elapse of a predefined time interval.

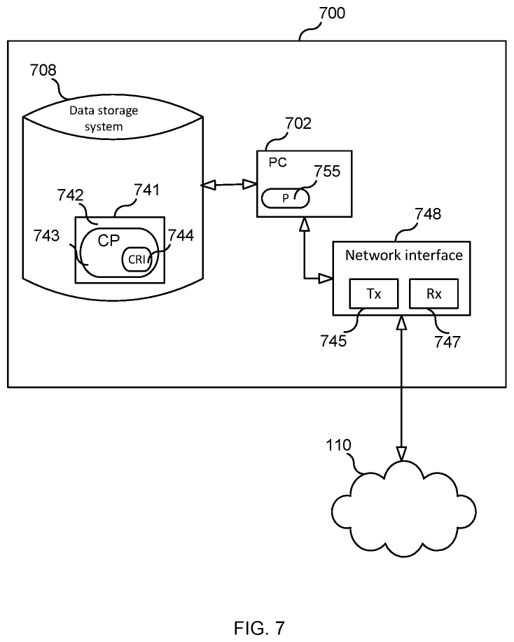

FIG. 7 is a block diagram of an apparatus according to some embodiments. Apparatus 700 may perform any of the methods or processes described above. As shown in FIG. 7, the apparatus 700 may comprise: processing circuitry (PC) 702, which may include one or more processors (P) 755 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., the network node may be a distributed computing apparatus); at least one network interface 748 comprising a transmitter (Tx) 745 and a receiver (Rx) 747 for enabling the network node to transmit data to and receive data from other nodes connected to a network 110 (e.g., an Internet Protocol (IP) network) to which network interface 748 is connected (directly or indirectly) (e.g., network interface 748 may be wirelessly connected to the network 110, in which case network interface 748 is connected to an antenna arrangement); and a storage unit (a.k.a., “data storage system”) 708, which may include one or more non-volatile storage devices and/or one or more volatile storage devices. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes the network node to perform steps described herein (e.g., steps described herein with reference to one or more of the flow charts). In other embodiments, the apparatus may be configured to perform steps described herein without the need for code. That is, for example, PC 702 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A computer-implemented method for updating a global machine learning (ML) model using distributed learning, the method comprising:
obtaining from a first group of one or more local computing devices weight values of a first group of one or more local ML models, wherein the weight values of the first group of one or more local ML models are generated based on a first type of input data;
obtaining from a second group of one or more local computing devices weight changing values, wherein the weight changing values are generated based on a second type of input data, and further wherein the first type of input data and the second type of input data are different;
updating the global ML model based on the weight values of the first group of one or more local ML models and the weight changing values, thereby obtaining an updated global ML model; and
transmitting to the first group of one or more local computing devices the updated global ML model.

2. The computer-implemented method of claim 1, wherein the updated global ML model is not transmitted to the second group of one or more local computing devices.

3. The computer-implemented method of claim 1, wherein a weight changing value included in the weight changing values corresponds to a difference between a weight value of a first local ML model and a weight value of a second local ML model.

4. The computer-implemented method of claim 1, comprising:
before obtaining the weight values of the first group of one or more local ML models and the weight changing values, transmitting weight values of the global ML model to the first group of one or more local computing devices and the second group of one or more local computing devices.

5. The computer-implemented method of claim 4, wherein
the second group of one or more local computing devices includes a first local computing device,
the first local ML model is obtained by updating the global ML model at the first local computing device using first local data which is of the second type, and
the second local ML model is obtained by updating the global ML model at the first local computing device using second local data which is of the second type.

6. The computer-implemented method of claim 5, wherein
obtaining the weight changing values comprises receiving from the first local computing device the weight changing value, and
the first local computing device transmitted the weight changing value when one or more preconditions are satisfied.

7. The computer-implemented method of claim 6, wherein said one or more preconditions include one or more of: availability of the first local data, availability of the second local data, or elapse of a predefined time interval.

8. The computer-implemented method of claim 1, comprising:
combining the weight values of the first group of one or more local computing devices, thereby generating combined weight values, wherein
the global ML model is updated based on the combined weight values.

9. The computer-implemented method of claim 8, wherein
$${G}_{m} = {\sum }_{j = 1}^{N} {l}_{m , j ,}$$
where
Gₘ is m-th combined weight value included in the combined weight values,
$$1 \leq m \leq M ,$$
M is a total number of the combined weight values,
l_{m,j} is m-th weight value of an j-th local ML model included in the first group of one or more local ML models, and
N is a total number of ML models included in the first group of one or more local ML models.

10. The computer-implemented method of claim 1, comprising:
combining the weight changing values, thereby generating combined weight changing values, wherein
the global ML model is updated based on the combined weight changing values.

11. The computer-implemented method of claim 10, wherein
$$Δ {G}_{n} = {\sum }_{j = 1}^{N} Δ {G}_{n , j} ,$$
where
ΔGₙ is n-th combined weight changing value included in the combined weight changing values,
$$1 \leq n \leq {M}^{′} ,$$
M′ is a total number of the combined weight changing values,
ΔG_{n,j} is n-th weight changing value associated with j-th local computing device included in the second group of one or more local computing devices, and
N is a total number of local computing devices included in the second group of one or more local computing devices.

12. The computer-implemented method of claim 10, comprising:
applying an adjusting value to the combined weight changing values; and
combining the combined weight values and the adjusted-combined weight changing values, wherein
the global ML model is updated based on the combination.

13. The computer-implemented method of claim 12, wherein the combined weight values and the adjusted-combined weight changing values are combined using knowledge distillation.

14. The computer-implemented method of claim 12, wherein
$${G}_{m} = {G}_{m - th combined weight value} + α {G}_{m - th combined weight changing value}$$
where Gₘ is an m-th weight value of the updated global ML model, G_{m-th combined weight value} is an m-th combined weight value in the combined weight values,
G_{m-th combined weight changing value} is an m-th combined weight changing value in the combined weight changing values, and α is the adjusting value.

15. The computer-implemented method of claim 3, wherein
a local computing device included in the first group of one or more local computing devices is a first base station in a communication network,
a local computing device included in the second group of one or more local computing devices is a second base station in the communication network,
the updated global ML model is configured to generate an output value indicating a faulty operation of the first base station based on the first type of input data; and
each of the second local ML model and the third local ML model is configured to generate an output value indicating a faulty operation of the second base station based on the second type of input data.

16. The computer-implemented method of claim 3, wherein
a local computing device included in the first group of one or more local computing devices is a first manufacturing device,
a local computing device included in the second group of one or more local computing devices is a second manufacturing device,
the updated global ML model is configured to generate an output value indicating a faulty manufacturing operation of the first manufacturing device based on the first type of input data; and
each of the second local ML model and the third local ML model is configured to generate an output value indicating a faulty manufacturing operation of the second manufacturing device based on the second type of input data.

17. A computer-implemented method for updating a global machine learning (ML) model using distributed learning, the method comprising:
obtaining from a global computing device a global ML model;
updating the global ML model using first local data, thereby generating a first local ML model;
updating the global ML model using second local data, thereby generating a second local ML model;
generating weight changing values using the first local ML model and the second local ML model; and
transmitting to the global computing device the weight changing values for updating the global ML model at the global computing device.

18.-20. (canceled)

21. A computer program product comprising a non-transitory computer readable medium storing a computer program comprising instructions which, when executed by processing circuitry, cause the processing circuitry to perform the method of claim 1.

22. (canceled)

23. An apparatus for updating a global machine learning (ML) model using distributed learning, the apparatus being configured to:
obtain from a first group of one or more local computing devices weight values of a first group of one or more local ML models, wherein the weight values of the first group of one or more local ML models are generated based on a first type of input data;
obtain from a second group of one or more local computing devices weight changing values, wherein the weight changing values are generated based on a second type of input data, and further wherein the first type of input data and the second type of input data are different;
update the global ML model based on the weight values of the first group of one or more local ML models and the weight changing values, thereby obtaining an updated global ML model; and
transmit to the first group of one or more local computing devices the updated global ML model.

24. (canceled)

25. An apparatus for updating a global machine learning (ML) model using distributed learning, the apparatus being configured to:
obtain from a global computing device a global ML model;
update the global ML model using first local data, thereby generating a first local ML model;
update the global ML model using second local data, thereby generating a second local ML model;
generate weight changing values using the first local ML model and the second local ML model; and
transmit to the global computing device the weight changing values for updating the global ML model at the global computing device.

26.-27. (canceled)
